(19) United States
(12) Patent Application Publication
(10) Pub. No.: US 2006/0007133 A1
(43) Pub. Date: Jan. 12, 2006

(54) Human input device and method for supplying power to the same

(76) Inventor: Young-Ho Shin, Yongin-si (KR)

Correspondence Address: CANTOR COLBURN, LLP, 55 GRIFFIN ROAD SOUTH, BLOOMFIELD, CT, 06002, US

(21) Appl. No.: 11/145,668

(22) Filed: Jun. 6, 2005

(30) Foreign Application Priority Data
Jun. 7, 2004 (KR) 2004-41508

(51) Int. Cl. G09G 5/00

(52) U.S. Cl. 345/156

(57) ABSTRACT

A human input device and a method for supplying power to the same are provided. The human input device includes: at least two input sensors for detecting movement; and a power controller for supplying power to at least one operating input sensor of the input sensors, and for blocking the power supplied to the other input sensor. Therefore, it is possible to reduce power consumption on the human input device including at least two input sensors for detecting movement.

This U.S. non-provisional patent application claims priority under 35 U.S.C. § 119 of Korean Patent Application 2004-41508 filed on Jun. 7, 2004, the entire contents of which are hereby incorporated by reference.

### BACKGROUND OF THE INVENTION

1. Field of the Invention

The present invention relates to a human input device and, more particularly, to a human input device including at least two input sensors for detecting movement to thereby be capable of reducing power consumption, and a method for supplying power to the same.

2. Description of Related Art

Recently, a human input device, such as an optical mouse, for inputting information on movement of a cursor into a computer or an information appliance mostly includes a separate input device in order to perform a function of causing entire display area to move up, down or across the screen, in addition to a function of moving the cursor on the screen depending on the movement of the human input device. Generally, when a entire display area is intended to move on the screen using the separate input device, the human input device such as the optical mouse does not move. Further, while the human input device such as the optical mouse moves, the separate input device is not used.

FIG. 1 is a block diagram of a conventional human input device, which includes a movement sensor 10, a scroll sensor 20, a button 30, a controller 40, and a power source 50.

Hereinafter, a function of each block shown in FIG. 1 will be described.

The movement sensor 10 detects movement of the human input device to output movement information MOV1. For example, the movement sensor 10 can detect light inputted from the outside and generate the movement information MOV1. The scroll sensor 20 detects movement of a scroll device mounted to the human input device to output scroll information MOV2. For example, when a user moves the scroll device such as a wheel mounted to the optical mouse, the scroll sensor 20 detects the movement to output the scroll information MOV2 used to move the entire screen in a longitudinal or transverse direction. The user manipulates the button 30, and button information BT defined previously in response to the manipulation is outputted. The controller 40 calculates a movement value using the movement information MOV1 and the scroll information MOV2 to output the movement value to an external device such as a computer, and simultaneously outputs a functional signal for performing a function defined previously in response to the button information BT to the external device (not shown) such as the computer. The power source 50 supplies power to the movement sensor 10, the scroll sensor 20, the button 30, and the controller 40.

The movement sensor 10 may be composed of an image sensor including a complementary metal oxide semiconductor (CMOS) device, and the scroll sensor 20 may be composed of a light emitting diode (LED) and a light receiving device, or a mechanical switch. In any case, there is nothing but to consume power to obtain the movement information and the scroll information by operation of the sensors 10 and 20.

Therefore, in the case of the conventional human input device, there are applied methods for reducing consumption of power. For example, when the human input device does not move with respect to the movement sensor 10 for a predetermined time, the power is intermittently supplied from the power source 50 to determine whether the human input device moves or not, and then, only when the movement of the human input device is detected, the power is supplied to the movement sensor 10 again. However, since the power is always supplied to the scroll sensor 20, the power consumption is unnecessarily generated.

In addition, in using the human input device as described above, there is little probability of simultaneously operating the movement sensor 10 and the scroll sensor 20. That is, there is little probability of moving the human input device while manipulating the scroll device. However, even when the conventional human input device operates, i.e., even when the movement sensor 10 operates, the power is also supplied to the scroll sensor 20 to generate unnecessary power consumption.

Recently, since the human input device often operates in a wireless manner, the above-mentioned unnecessary power consumption causes an operation use time of the wireless human input device to be shortened.

### SUMMARY OF THE INVENTION

Therefore, to solve the problem described hereinabove, an object of the present invention is to provide a human input device including at least two input sensors, thereby being capable of reducing power consumption.

Another object of the present invention is to provide a method for supplying power to the human input device.

A human input device according to a first aspect of the present invention includes at least two input sensors for detecting movement, and a power controller for supplying power to at least one operating input sensor of the input sensors, and for blocking the power supplied to the other input sensor.

The power controller may further include a function of intermittently supplying power to the respective sensors, when all of the input sensors do not operate.

The power controller may further include a function of intermittently supplying power to one sensor of the input sensors, when all of the input sensors do not operate.

The power controller may further include a function of supplying power to one sensor of the input sensors on the basis of priority, when the plurality of sensors operate.

The input sensors may include a movement sensor for detecting movement, and a scroll sensor for detecting a scroll.

The power controller may further include a function of intermittently supplying power to the scroll sensor, when both of the movement sensor and the scroll sensor do not operate.

The power controller may further include a function of intermittently supplying power to the movement sensor, when both of the movement sensor and the scroll sensor do not operate.

The power controller may further include a function of intermittently supplying power to both of the movement sensor and the scroll sensor, when both of the movement sensor and the scroll sensor do not operate. The power controller may further include a function of supplying power only to any one of the movement sensor and the scroll sensor on the basis of priority when both of the movement sensor and the scroll sensor operate.

A method for supplying power to a human input device including at least two input sensors for detecting movement in accordance with a second aspect of the present invention includes determining whether each of the input sensors operates or not, and controlling power supply by applying the power to at least one operating input sensor of the input sensors, and blocking the power supplied to the other sensor.

The method may further include intermittently supplying power to each of the input sensors, when all of the input sensors do not operate.

The method may further include intermittently supplying power to one sensor of the input sensors, when all of the input sensors do not operate.

The method may further include supplying power to at least one sensor of the input sensors on the basis of priority, when the plurality of input sensors operate.

### BRIEF DESCRIPTION OF THE DRAWINGS

The foregoing and other objects, features and advantages of the invention will be apparent from the more particular description of a preferred embodiment of the invention, as illustrated in the accompanying drawing. The drawing is not necessarily to scale, emphasis instead being placed upon illustrating the principles of the invention.

FIG. 1 is a block diagram of a conventional human input device;

FIG. 2 is a block diagram illustrating an embodiment of a human input device in accordance with the present invention; and

FIG. 3 is a flow chart showing an operation of a controller of a human input device shown in FIG. 2 in accordance with the present invention.

### DETAILED DESCRPTION OF THE INVENTION

Hereinafter, the detailed description of a preferred embodiment in accordance with the present invention will be apparent in connection with the accompanying drawings.

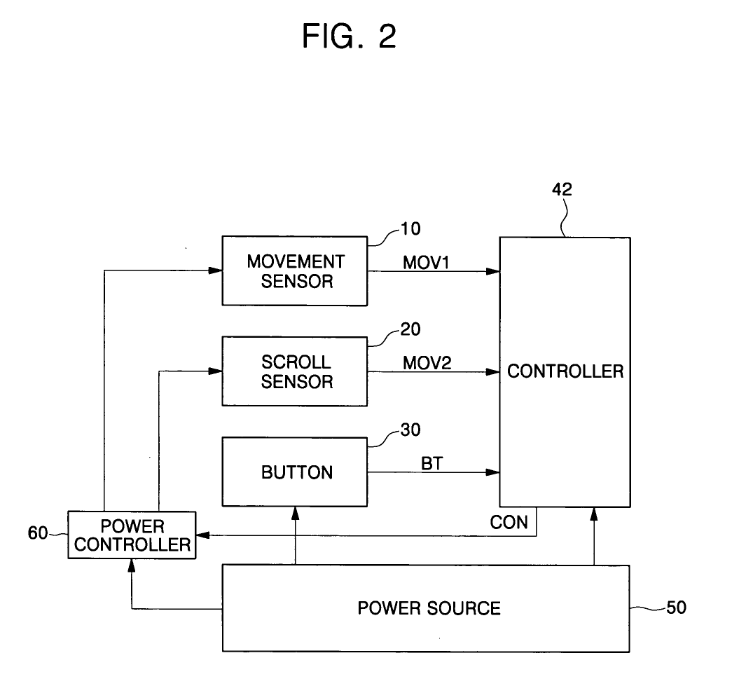

FIG. 2 is a block diagram of a human input device in accordance with the present invention, which includes a movement sensor 10, a scroll sensor 20, a button 30, a controller 42, a power source 50, and a power supply controller 60.

Each function of the blocks shown in FIG. 2 will be described as follows.

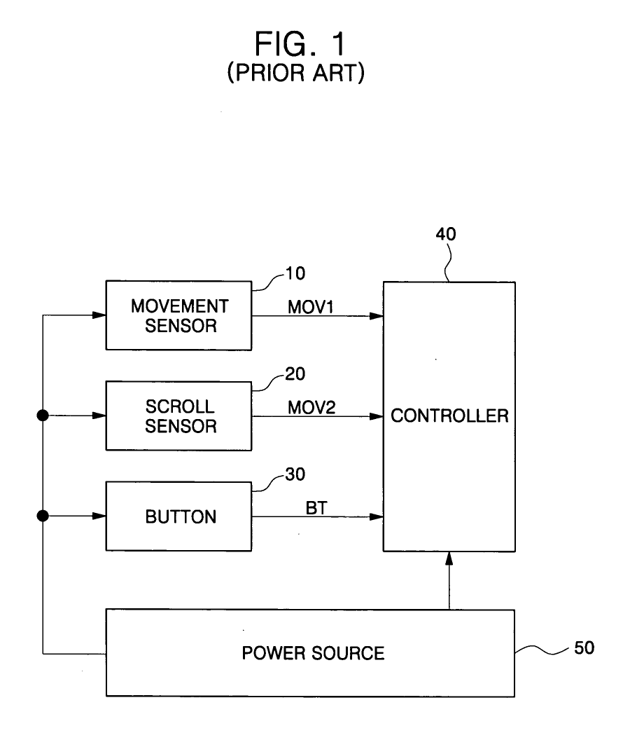

The functions of the movement sensor 10, the scroll sensor 20, and the button 30 are the same as described in FIG. 1.

The controller 42 has the same basic function as described in FIG. 1, and outputs a power control signal CON to the power supply controller 60 in response to both movement information MOV1 inputted from the movement sensor 10 and scroll information MOV2 inputted from the scroll sensor 20.

The power source 50 supplies power to the controller 42 and the button 30, and supplies power to the movement sensor 10 and the scroll sensor 20 through the power supply controller 60. The power source 50 may be a power supply line connected to an external device such as a computer when the human input device is a wired device, and may include a transformer in addition to the power supply line when power transformation to a desired voltage is required. In addition, when the human input device is a wireless device, the power source may be a battery, and may also include the power transformer to generate a desired voltage from the battery.

The power supply controller 60 supplies or blocks the power of the power source 50 to the movement sensor 10 and/or the scroll sensor 20 in response to the power control signal CON.

That is, the human input device of the present invention determines whether either the movement sensor 10 or the scroll sensor 20 operates using the movement information MOV1 and the scroll information MOV2 through the controller 42. As a result of the determination, when any one of the two sensors 10 and 20 operates, the power controller 60 through the controller 42 supplies the power to the one operating sensor, and blocks the power supplied to the other sensor. When the two sensors 10 and 20 do not operate, the power controller 60 through the controller 42 intermittently supplies the power to one of the sensors 10 and 20 to determine whether the human input device operates, and when the movement is detected, the power controller through the controller 42 supplies the power only to the sensor operating in the same manner as described above. When the two sensors 10 and 20 operate, the power controller 60 through the controller 42 supplies the power to both of the two sensors 10 and 20, or only any one of both sensors on the basis of predetermined priority.

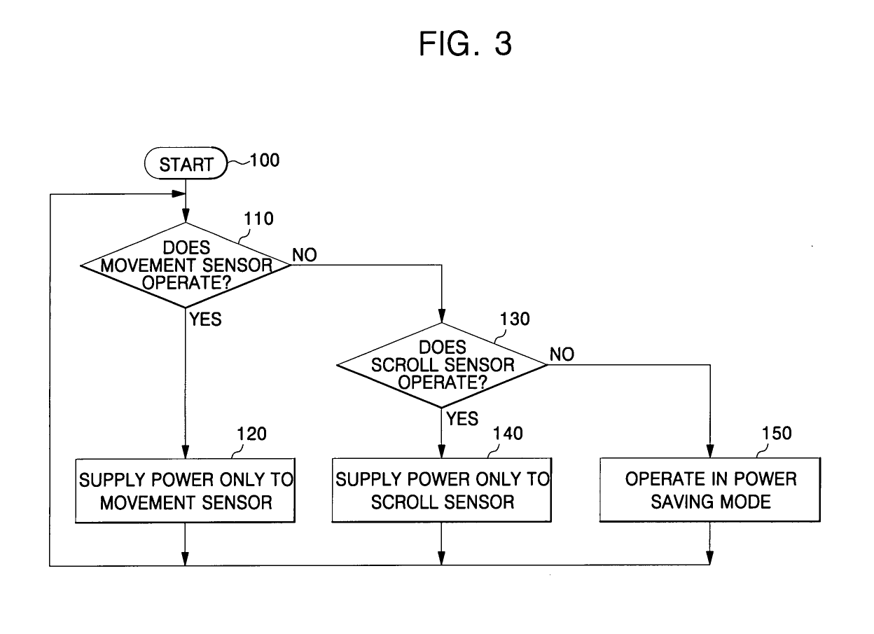

FIG. 3 is a flow chart showing an operation of the controller 42 and the power controller 60 of the human input device shown in FIG. 2 in accordance with the present invention, in which, when two sensors 10 and 20 operate, the movement sensor 10 is set to have higher priority.

An operation of the controller 42 of the human input device in accordance with the present invention will be described in conjunction with FIG. 3.

The controller 42 determines whether the movement sensor 10 operates using the movement information MOV1 or not (Step 110). As a result of the determination in Step 110, when the movement sensor 10 operates, the controller 42 outputs the power supply signal CON to the power controller 60 in such a way that power is supplied to the movement sensor 10 alone, but power supplied to the scroll sensor 20 is blocked (Step 120).

As a result of the determination in Step 110, when the movement sensor 10 does not operate, the controller 42 determines whether the scroll sensor 20 operates or not (Step130). As a result of the determination in Step 130, when the scroll sensor 20 operates, the controller 42 outputs the power supply signal CON to the power controller 60 in such a way that power supplied to the movement sensor 10 is blocked, but power is supplied only to the scroll sensor 20 (Step 140).

As a result of the determination in Step 130, when the scroll sensor 20 does not operate as well, a power saving mode is performed (S150). That is, the controller 42 intermittently supplies the power to both of the movement sensor 10 and the scroll sensor 20, or any one of both of the sensors 10 and 20, to determine whether the human input device operates or not, and then when the human input device operates, the controller 42 determines again whether the movement sensor 10 operates or not (S110).

FIG. 3 illustrates that when the movement sensor 10 has higher priority, i.e., when both the movement sensor 10 and the scroll sensor 20 operate, power is supplied to the movement sensor 10 only. On the other hand, we can also range that the scroll sensor 20 has a higher priority order. In addition, when both of the movement sensor 10 and the scroll sensor 20 operate, the controller 42 may supply power to both of the sensors 10 and 20.

Therefore, the human input device according to the present invention is capable of minimizing power consumption by determining which of the movement sensor 10 and the scroll sensor 20 operates and then supplying power to the operating sensor alone.

As described above, the present invention has been described by taking the case that the human input device includes two sensors, i.e., the movement sensor and the scroll sensor, for detecting movement, as an example. However, the present invention may be also applied to the human input device having at least two input sensors.

In addition, while the present invention has been described by taking the optical mouse as an example, it may be applied to the case that the human input device other than the optical mouse includes a plurality of input sensors.

As can be seen from the foregoing, the human input device including at least two input sensors for detecting movement and the method for supplying power to the same in accordance with the present invention are capable of reducing power consumption. Therefore, the human input device is possible to increase the operation use time thereof when it operates by wireless.

While this invention has been described in connection with what is presently considered to be the most practical and preferred embodiment, it is to be understood that the invention is not limited to the disclosed embodiment, but on the contrary, it is intended to cover various modification within the spirit and the scope of the invention, which is set forth in the appended claims.

What is claimed is:

1. A human input device comprising:
at least two input sensors for detecting movement; and
a power controller for supplying power to at least one operating input sensor of the input sensors, and for blocking power supplied to the other input sensor.

2. The human input device according to claim 1, wherein the power controller further comprises a function of intermittently supplying power to the respective sensors when all of the input sensors do not operate.

3. The human input device according to claim 1, wherein the power controller further comprises a function of intermittently supplying power only to any one of the input sensors when all of the input sensors do not operate.

4. The human input device according to claim 1, wherein the power controller further comprises a function of supplying power only to at least one of the input sensors on the basis of priority when the plurality of sensors operate.

5. The human input device according to claim 1, wherein the input sensors comprise:
a movement sensor for detecting movement; and
a scroll sensor for detecting scroll operation.

6. The human input device according to claim 5, wherein the power controller further comprises a function of intermittently supplying power to the scroll sensor when both of the movement sensor and the scroll sensor do not operate.

7. The human input device according to claim 5, wherein the power controller further comprises a function of intermittently supplying power to the movement sensor when both of the movement sensor and the scroll sensor do not operate.

8. The human input device according to claim 5, wherein the power controller further comprises a function of intermittently supplying power to both of the movement sensor and the scroll sensor when both of the movement sensor and the scroll sensor do not operate.

9. The human input device according to claim 5, wherein the power controller further comprises a function of supplying power only to any one of the movement sensor and the scroll sensor on the basis of priority when both of the movement sensor and the scroll sensor operate.

10. A method for supplying power to a human input device including at least two input sensors for detecting movement, comprising:
determining whether each of the input sensors operates or not; and
controlling power supply by applying the power to at least one operating input sensor of the input sensors, and blocking the power supplied to the other sensor.

11. The method according to claim 10, further comprising intermittently supplying power to each of the input sensors when all of the input sensors do not operate.

12. The method according to claim 10, further comprising intermittently supplying power only to any one of the input sensors when all of the input sensors do not operate.

13. The method according to claim 10, further comprising supplying power only to at least one of the input sensors on the basis of priority when the plurality of input sensors operate.
